(19) United States
(12) Patent Application Publication
(10) Pub. No.: US 2004/0240357 A1
(43) Pub. Date: Dec. 2, 2004

(54) Method and apparatus for discriminating optical disks

(75) Inventor: Noriyoshi Takeya, Yokohama (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 10/696,427

(22) Filed: Oct. 28, 2003

(30) Foreign Application Priority Data
Oct. 31, 2002 (JP) 2002-319058

(51) Int. Cl. G11B 7/00

(52) U.S. Cl. 369/53.22

(57) ABSTRACT

Disclosed herein is a method and apparatus for discriminating optical disks, which can discriminate various kinds of optical disks which are seated on an information recording and reproducing system with high precision. In the present invention, laser light is irradiated onto an optical disk from an LD (101) for CDs, and light, which can be reflected from the optical disk, is detected by a PD (104) for CDs and a PD (105) for DVDs or PD (106) for HD-DVDs. The type of seated optical disk is discriminated on the basis of detection results.

### BACKGROUND OF THE INVENTION

1. Field of the Invention

The present invention relates generally to a method and apparatus for discriminating optical disks, and more particularly to a method and apparatus for discriminating optical disks, which is used in an information recording and reproducing system capable of handling various kinds of optical disks which are information recording media.

2. Description of the Prior Art

Recently, phase change recording media and magneto-optical recording media have been utilized as large-capacity information recording media capable of recording information with high density. For example, the phase change recording media are reproduction exclusive optical disks, recordable optical disks capable of being recorded with information, and rewritable optical disks capable of being erased and rewritten with information. Further, the magneto-optical recording media are basically capable of being erased and rewritten with information.

Further, in recent years, a plurality of optical disks having the same exterior shapes and different recording capacities have been developed. In an information recording and reproducing system (Combo drive) capable of handling the above-described plural optical disks differing in recording formats and recording capacities, it is necessary to discriminate the types of optical disks seated on the combo drive. In the prior art, the discrimination of optical disks seated on the combo drive is carried out according to the following process.

For example, an object lens for guiding laser light emitted from a laser light source to an optical disk while focusing the laser light is moved in the direction of an optical axis. The type of optical disk is discriminated using the timing of generation of a S-curve, which a Focus Error (FE) signal, generated by laser light reflected from the optical disk during the movement of the object lens in the direction of the optical axis, represents, and the amplitude of the FE signal. This discriminating method is disclosed in, for example, Japanese Patent Laid-open Publication No. 9-320179.

However, the above-described conventional combo drive is problematic in that, since the discrimination of optical disks depends on the timing of generation of the S-curve, the amplitude of the FE signal and the like, some optical disks cannot be accurately discriminated due to the differences between reflection factors of optical disks or between generated FE signals, caused by differences in thickness between optical disks or manufacturing error. Further, as the capacity of optical disks increases, the types of optical disks which can be seated on the combo drive increase, so the criteria for discrimination becomes strict. Accordingly, if the conventional discriminating method is continuously used as it is, the precision of discrimination may be deteriorated.

### SUMMARY OF THE INVENTION

Accordingly, the present invention has been made keeping in mind the above problems occurring in the prior art, and an object of the present invention is to provide a method and apparatus for discriminating optical disks, which can discriminate various kinds of optical disks seated on an information recording and reproducing system with high precision.

In accordance with one aspect of the present invention, the above object can be accomplished by the provision of a method of discriminating types of plural discs with different track pitches and/or different reflection factors and/or different cover layer thicknesses, the disks being seated on an information recording and reproducing system that records and reproduces information using different wavelengths, comprising the steps of a) irradiating laser light with a specific wavelength onto an optical disk; b) detecting light, which can be obtained by irradiating the laser light onto the optical disk, using a first detecting element suitable for light with the specific wavelength and/or for specific track pitch; c) detecting light, which can be obtained by irradiating the laser light onto the optical disk, using a second detecting element suitable for light with another wavelength and/or for another track pitch; and d) discriminating a type of optical disk on the basis of detection results obtained at the steps b) and c).

According to the present invention, the type of optical disk is discriminated on the basis of more information than is included in light which can be reflected from the optical disk using detection results of the first and second detecting elements having different characteristics, thus discriminating various kinds of optical disks seated on an information recording and reproducing system with high precision.

In accordance with another aspect of the present invention, the above object can be accomplished by the provision of a method of discriminating types of disks seated on an information recording and reproducing system using a S-curve indicated by a focus error signal generated during movement of an object lens by a lens drive system, comprising the steps of storing and maintaining a signal level of a S-curve generated by feedback light which is emitted from a light source installed for a first optical disk and received by a light receiving element installed for a second optical disk; and utilizing the signal level for discrimination of the types of disks.

According to the present invention, the type of optical disk can be collectively discriminated using the signal level of a S-curve generated by feedback light, emitted from a light source element provided for one optical disk and received by a light receiving element provided for another optical disk, together with the timing of generation of the S-curve used in the prior art, thus increasing precision of discrimination of seated optical disks.

In accordance with one aspect of the present invention, the above object can be accomplished by the provision of an apparatus for discriminating types of disks seated on an information recording and reproducing system that records and reproduces information using different plural wavelengths, comprising at least two detecting elements having different detection sensitivities and/or different track pitches; and a discriminating unit for discriminating the types of optical disks on the basis of detection results which can be obtained by detecting light received from each of the optical disks through the detecting elements.

According to the present invention, the type of optical disk is discriminated on the basis of more information than is included in light which can be reflected from the optical disk using a plurality of detection results of detecting elements with different detection sensitivities and/or track pitches, thus discriminating various kinds of optical disks seated on an information recording and reproducing system with high precision.

In accordance with another aspect of the present invention, the above object can be accomplished by the provision of an apparatus for discriminating types of disks seated on an information recording and reproducing system using a S-curve indicated by a focus error signal generated during movement of an object lens by a lens drive system, comprising optical disk discriminating means for storing and maintaining a signal level of a S-curve generated by feedback light which is emitted, from a light source installed for a first optical disk and received by a light receiving element installed for a second optical disk, and utilizing the signal level for discrimination of the types of disks.

According to the present invention, the optical disk discriminating means discriminates the type of a seated optical disc using the signal level of a S-curve generated by feedback light, emitted from a light source element provided for one optical disk and received by a light receiving element provided for another optical disk, so there can be provided an optical disc discriminating apparatus which collectively discriminates optical disks using the signal level of the S-curve together with the timing of generation of the S-curve used in the prior art, thus improving the precision of discrimination of optical disks.

In this case, the optical disk discriminating means comprises a comparing circuit for discriminating a type of seated optical disk by comparing a voltage level indicated by the S-curve of the focus error signal with a voltage level generated by the feedback light, and/or comparing the voltage level generated by the feedback light with a reference value obtained when a suitable optical disk is seated.

According to the present invention, the comparing circuit compares feedback light beams received by two different light receiving elements with each other, and/or compares a corresponding feedback light beam with a preset reference value, so there can be provided an optical disc discriminating apparatus which collectively discriminates optical disks using the signal level of the S-curve together with the timing of generation of the S-curve used in the prior art, thus improving the precision of discrimination of optical disks.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of an apparatus for discriminating optical disks according to an embodiment of the present invention;

FIG. 2 is a block diagram of another apparatus for discriminating optical disks according to another embodiment of the present invention;

FIG. 3 is a view showing the detailed construction of an optical system of a pickup unit used in the embodiment of the present invention;

FIG. 4 is a waveform diagram showing examples of signals of a photodetector for CDs and a photodetector for HD-DVDs if a seated disk is a CD;

FIG. 5 is a waveform diagram showing examples of signals of the photodetector for CDs and the photodetector for HD-DVDs if a seated disk is a HD-DVD; and

FIG. 6 is a graph showing sensitivities to wavelengths of the photodetector for CDs and the photodetector for HD-DVDs.

### DESCRIPTION OF THE PREFERRED EMBODIMENTS

Hereinafter, a method and apparatus for discriminating optical disks according to embodiments of the present invention will be described in detail with reference to the attached drawings. In the present invention, an information recording and reproducing system may include a system having one of a function of reproducing information recorded on an optical disk which is an information recording medium and a function of recording information on an optical disk, as well as systems having both the functions. Further, in embodiments of the present invention, there will be described below examples in which three kinds of optical disks, such as a Compact Disk (CD), a Digital Versatile Disk (DVD, registered trademark), and a High Definition-DVD (HD-DVD, registered trademark), are used as optical disks.

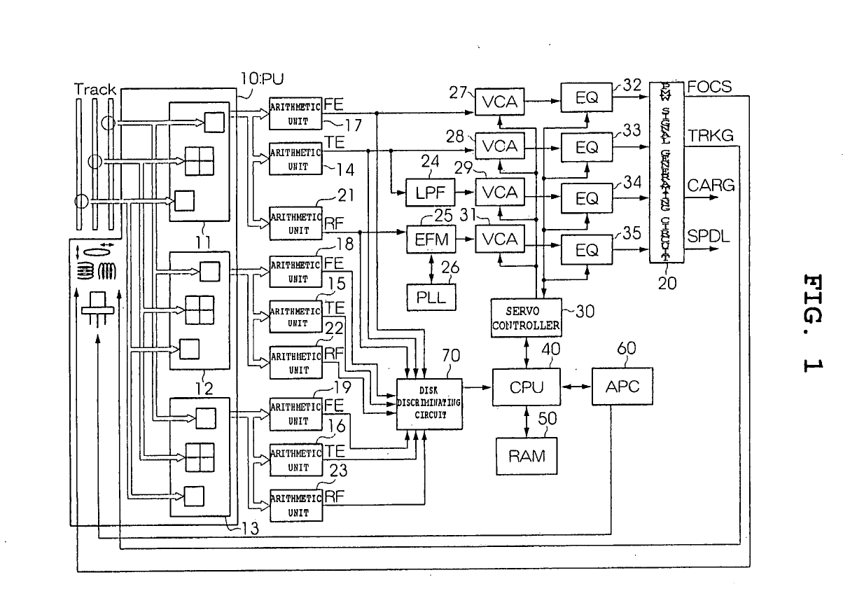

FIG. 1 is a block diagram of an apparatus for discriminating optical disks according to an embodiment of the present invention. In FIG. 1, a “Track” represents part of a track formed on an optical disk. As shown in FIG. 1, spots are formed at three different points on the optical disk by laser light emitted from an optical Pickup unit (PU) 10. These spots are used for performing tracking control based on a three-beam method.

The PU 10 includes a photodetector (PD) 11 for CDs, a photodetector 12 for DVDs and a photodetector 13 for HD-DVDs. Although depicted in brief in FIG. 1, a light source for CDs (wavelength: 780 nm), a light source for DVDs (wavelength: 650 nm), and a light source for HD-DVDs (wavelength: 405 nm) corresponding to the PDs 11 to 13, respectively, are mounted in the pickup unit 10.

First, a phase difference (TE: tracking error signal) is obtained through each of the light receiving elements mounted in the PU 10. The tracking error signal TE, obtained through an arithmetic unit 14, 15 or 16, is amplified by a Voltage Control Amplifier (VCA) 28 by a certain amplification factor. The amplified signal is converted to a digital signal by an Analog/Digital (A/D) converter (not shown). The digital signal is output to a Pulse Width Modulation (PWM) signal generating circuit 20 through a digital equalizer (EQ) 33, and simultaneously output to a servo controller 30. Further, an output of the arithmetic unit 14 is filtered by a Low Pass Filter (LPF) 24, the filtered result is amplified by a VGA 29 by a certain amplification factor, and then the amplified signal is converted to a digital signal by an A/D converter (not shown). The digital signal is output to the PWM signal generating circuit 20 through the EQ 33, and simultaneously output to the servo controller 30.

Further, a difference (FE: focus error signal) between signals of a four-division type PD provided in each of PDs 11 to 13 in the PU 10 is obtained. The focus error signal FE is amplified by a VCA 27 by a certain amplification factor, and the amplified signal is converted to a digital signal by an A/D converter (not shown). At this time, the digital signal is output to the PWM signal generating circuit 20 through an EQ 32, and simultaneously output to the servo controller 30.

Further, respective signals of the four-division type PD are added by an arithmetic unit 21, 22 or 23. The added result is converted to an RF signal by a circuit consisting of an Eight to Fourteen Modulation (EFM) demodulation circuit 25 and a Phase Locked Loop (PLL) circuit 26. The RF signal is converted to a digital signal by an A/D converter (not shown). The digital RF signal is output to the PWM signal generating circuit 20 through the EQ 35 and simultaneously output to the servo controller 30.

The PWM signal generating circuit 20 converts respective signals output from the EQs 32 to 35 to PWM signals. The output signal of the EQ 33, converted to the PWM signal, is output to the PU 10 as a tracking control signal TRKG, and the output signal of the EQ32, converted to the PWM signal, is output to the PU 10 as a focus control signal FOCUS. Further, the output signal of the EQ 34, converted to the PWM signal, is output as a drive signal CARG of a driving device (not shown) that moves the PU 10 in the radial direction of an optical disk. The output signal of the EQ 35, converted to the PWM signal, is output as a drive signal SPDL of a spindle motor (not shown) that rotates an optical disk.

The servo controller 30 performs control operations, such as tracking control, focus control, and rotation control of the spindle motor under the control of a Central Processing Unit (CPU) 40. Further, the servo controller 30 adjusts the gains of the VCAs 27, 28, 29 and 31 and the EQs 32 to 35 under the control of the CPU 40. A Random Access Memory (RAM) 50 temporarily stores therein information, such as gains set by the VCAs 27, 28, 29 and 31 and the EQs 32 to 35. An Auto Power Control (APC) circuit 60 is a circuit that drives each laser diode (LD) included in the PU 10 on the basis of a power detection result such that laser light emitted from the LD has certain intensity at the time of reproducing (or recording) information.

A disk discriminating circuit 70 discriminates the type of an optical disk seated on the information recording and reproducing system in cooperation with the CPU 40. The disk discriminating circuit 70 is provided with a comparing circuit that discriminates the type of a seated optical disk by comparing a voltage level indicated by a certain S-curve of a focus error signal FE with a voltage level generated by feedback light, which will be described later, and comparing the voltage level of the feedback light with a reference value obtained when a suitable optical disk is seated.

Further, the disk discriminating circuit 70 receives outputs of the arithmetic units 14 to 23, and discriminates the type of the optical disk seated on the information recording and reproducing system using signals output from the arithmetic units 14 to 23. In this embodiment, there is described an example in which the type of the seated optical disk is discriminated using signals output from the PD 11 for CDs and the PD 13 for HD-DVDs.

Further, in this embodiment, there is depicted in FIG. 1 a construction in which the output of the arithmetic unit 17 is input to the VCA 27, the output of the arithmetic unit 14 is input to the VCA 28, and the output of the arithmetic unit 21 is input to the EFM demodulation circuit 25 so as to describe a case where the type of the optical disk is discriminated by turning on the LD for CDs. However, for example, in the case where the type of an optical disk is discriminated by turning on the LD for DVDs, a switching operation is performed by a switch (not shown) such that the output of the arithmetic unit 18 is input to the VCA 27. Similar to this, the outputs of the arithmetic units 15 and 22 are also input to the VCA 28 and the EFM demodulation circuit 25, respectively, by the switch (not shown).

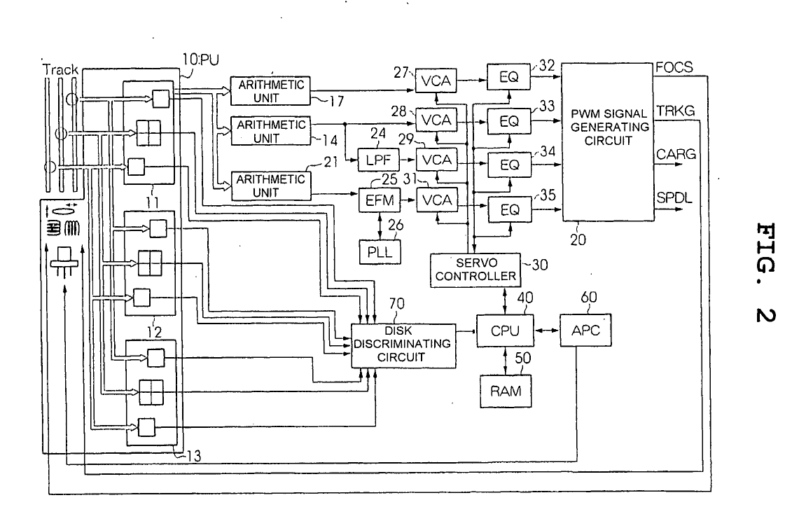

FIG. 2 is a block diagram of another apparatus for discriminating optical disks according to another embodiment of the present invention. The embodiments of FIGS. 1 and 2 are different in that the outputs of the arithmetic units 14 to 23 are provided to the disk discriminating circuit 70 in the embodiment of FIG. 1, while the output signals of PDs 11 to 13 are directly input to the disk discriminating circuit 70 in FIG. 2. Except for this, the remaining parts are the same as those of FIG. 1.

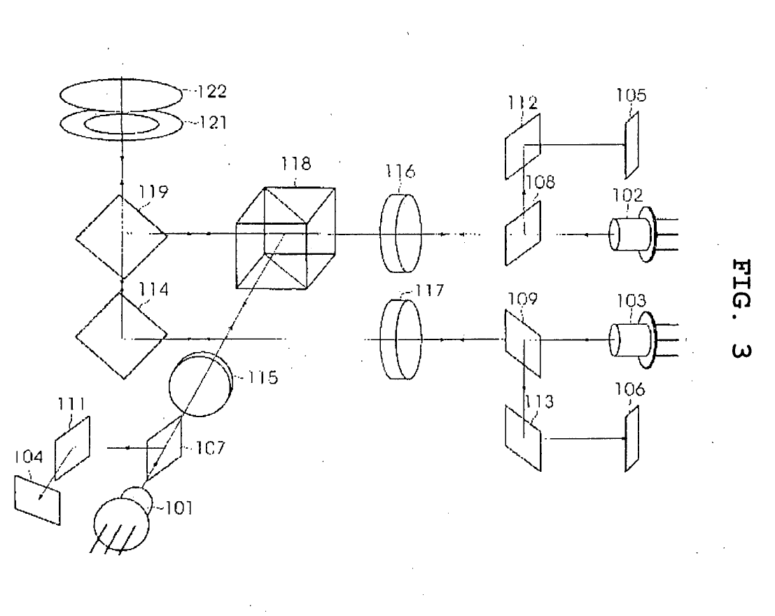

FIG. 3 is a view showing an example of the detailed construction of an optical system of the PU 10 used in the embodiment of the present invention. The PU 10 shown in FIGS. 1 and 2 comprises LDs 101 to 103 which are light sources, PDs 104 to 106 which are light detecting elements, half mirrors 107 to 109, total internal reflection mirrors 111 to 114, collimation lenses 115 to 117, a cube 118, a three-wavelength beam splitter 119, a Numerical Aperture (NA) converting element 121 and an object lens 122.

The LD 101 is used as a light source for CDs that emits laser light with a wavelength of 780 nm, the LD 102 is used as a light source for DVDs that emits laser light with a wavelength of 650 nm, and the LD 103 is used as a light source for HD-DVDs that emits laser light with a wavelength of 405 nm. Further, the PD 104 is a PD for CDs installed to correspond to the LD 101, the PD 105 is a PD for DVDs installed to correspond to the LD 102, and the PD 106 is a PD for HD-DVDs installed to correspond to the LD 103. In this case, the PDs 104 to 106 correspond to the PDs 11 to 13 of FIG. 1, respectively.

Laser light irradiated from the LD 101 reaches the collimation lens 115 for CDs, the cube 118 and the three-wavelength beam splitter 119 through the half mirror 107 for CDs, reaches the object lens 122 through the NA converting element 121, and is then focused through the object lens 122. If the focused laser light is reflected from an optical disk (not shown), the reflected light reaches the half mirror 107 through the object lens 122 along a path opposite to the above path, and is reflected from the half mirror 107, and then is detected by the PD 104 for CDs through the total internal reflection mirror 111 for CDs.

Further, laser light irradiated from the LD 102 reaches the collimation lens 116 for DVDs, the cube 118 and the three-wavelength beam splitter 119 through the half mirror 108 for DVDs, reaches the object lens 122 through the NA converting element 121, and is then focused through the object lens 122. If the focused laser light is reflected from an optical disk (not shown), the reflected light reaches the half mirror 108 through the object lens 122 along a path opposite to the above path, and is reflected from the half mirror 108, and then is detected by the PD 105 for DVDs through the total internal reflection mirror 112 for DVDs.

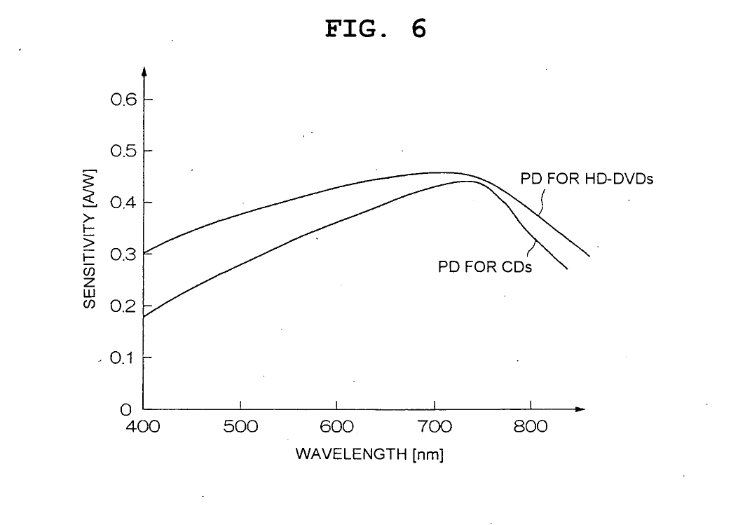

Further, laser light irradiated from the LD 103 reaches the collimation lens 117 for HD-DVDs, the total internal reflection mirror 114 for HD-DVDs and the three-wavelength beam splitter 119 through the half mirror 109 for HD-DVDs, reaches the object lens 122 through the NA converting element 121, and is then focused through the object lens 122. If the focused laser light is reflected from an optical disk (not shown), the reflected light reaches the half mirror 109 for HD-DVDs through the object lens 122 along a path opposite to the above path, and is reflected from the half mirror 109 for HD-DVDs, and then is detected by the PD 106 for HD-DVDs through the total internal reflection mirror 113 for HD-DVDs. For reference, the sensitivities to wavelengths of the PD 104 for CDs and the PD 106 for HD-DVDs are depicted in FIG. 6.

One actuator installed in the PU 10 moves the object lens 122 in the direction of an optical axis of laser light (direction perpendicular to a recording surface of an optical disk) for the purpose of performing focusing. The other actuator moves the object lens 122 in a direction orthogonal to the optical axis direction of laser light (radial direction of disk) for the purpose of performing tracking. The distance the object lens 122 is moved by the one actuator is controlled by an input focus control signal (FOCS of FIGS. 1 and 2), and the distance the object lens 122 is moved by the other actuator is controlled by an input tracking control signal (TRKG of FIGS. 1 and 2).

If the object lens 122 is moved in the direction of the optical axis of laser light in response to the focus control signal, the focus error signal is output depending on a difference between focuses of the object lens 122 on the optical disk, thus obtaining a so-called S-curve.

However, if the laser light irradiated from each of the LDs 101 to 103 reaches the optical disk along the path indicated in FIG. 3, light reflected from the optical disk is detected by each of the PDs 104 to 106, such that information recorded on the seated optical disk is read. However, the cube 118 and the three-wavelength beam splitter 119 split laser light beams with wavelengths of 780 nm, 650 nm and 405 nm, respectively, at the wavelength ratios, so a certain amount of laser light, for example, several %, is received by PDs other than a PD by which each laser light beam must be originally received.

For example, it is assumed that, if a CD is seated on the information recording and reproducing system, a signal level of a S-curve detected by the PD 104 for CDs is designed to be 2Vₚ₋ₚ if a DVD is seated thereon, a signal level of a S-curve detected by the PD 105 for DVDs is designed to be 2Vₚ₋ₚ, and if a HD-DVD is seated thereon, a signal level of a S-curve detected by the PD 106 for HD-DVDs is designed to be 2Vₚ₋ₚ.

In this state, if a CD is seated on the information recording and reproducing system as an optical disk and so laser light is emitted from the LD 101 for CDs, approximately 5% of the laser light is received as feedback light by the PD 105 for DVDs according to optical characteristics of the three-wavelength beam splitter 119 and the cube 118. In the case of the PD 106 for HD-DVDs, the same phenomenon occurs. Therefore, in this case, a S-curve with approximately 2Vₚ₋ₚ×0.05=100 mVₚ₋ₚ can also be obtained by the PD 105 for DVDs.

In the present invention, when the CD is seated, a signal level, which can be obtained by the PD installed for another use not for CDs, that is, the PD 105 for DVDs, is stored and maintained in the disk discriminating circuit 70 shown in FIGS. 1 and 2. Further, the obtained signal level is compared with reference values obtained when suitable optical disks, that is, DVD and/or HD-DVD in this case, are seated, and/or a signal level which can be obtained by the PD 104 for CDs and/or a signal level which can be obtained by the PD 106 for HD-DVDs, thus discriminating the type of seated optical disk.

In this case, the discrimination of the type of seated optical disk is carried out in cooperation with the CPU 40, but, except that the feedback light is also used as criteria for the discrimination, the remaining discrimination procedure is the same as a conventional discriminating method. First, laser light with a wavelength of 780 nm is irradiated to determine whether a seated optical disk is a CD, DVD or HD-DVD.

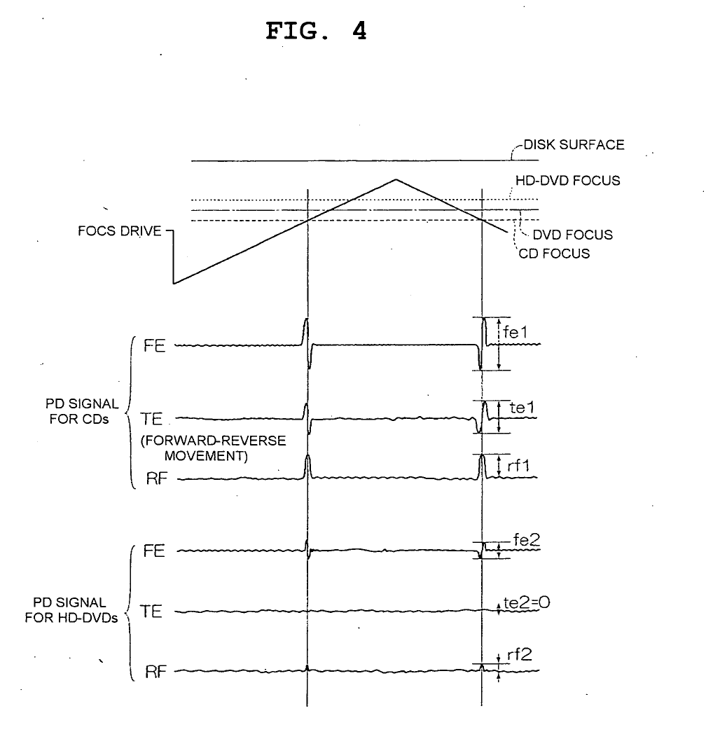

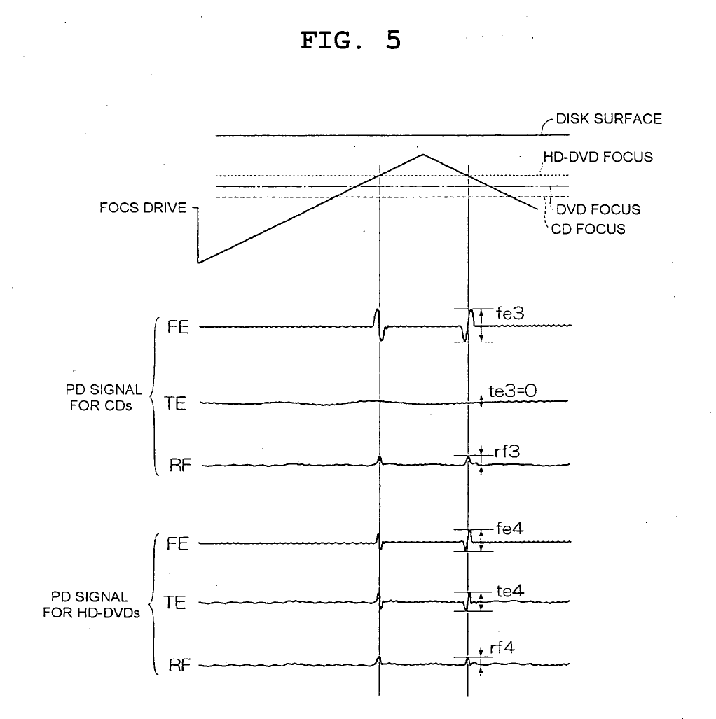

FIG. 4 is a waveform diagram showing examples of signals of the PD 104 for CDs and the PD 106 for HD-DVDs if a seated disk is a CD. FIG. 5 is a waveform diagram showing examples of signals of the PD 104 for CDs, and the PD 106 for HD-DVDs if a seated disk is a HD-DVD. Further, FIGS. 4 and 5 illustrate waveforms of a focus error signal FE, a tracking error signal TE, and an RF signal detected when laser light with a wavelength of 780 nm is irradiated from the LD 101 for CDs.

Referring to FIG. 4, if laser light is irradiated from the LD 101 for CDs, and the object lens 122 is reciprocated in the direction of an optical axis of the laser light, a S-curve is obtained as a focus error signal FE by the PD 104 for CDs when the object lens 122 is focused on a recording surface of the CD. As shown in FIG. 4, at the time the S-curve is output from the PD 104 for CDs, a S-curve can also be obtained as a focus error signal FE by the PD 106 for HD-DVDs. In this embodiment, the type of seated optical disk is discriminated on the basis of a ratio or difference between the intensity fe1 of the S-curve output from the PD 104 for CDs and the intensity fe2 of the S-curve output from the PD 106 for HD-DVDs, and/or a ratio or difference between the intensity fe2 (HD)=2Vₚ₋ₚ of a S-curve output from the PD 106 for HD-DVDs in the case where laser light with a wavelength of 405 nm is irradiated from the LD for HD-DVDs, and the intensity fe2.

Further, referring to FIG. 5, if laser light is emitted from the LD 101 for CDs and the object lens 122 is reciprocated in the direction of an optical axis of the laser light, S-curves can be obtained as focus error signals FEs by the PD 104 for CDs and the PD 106 for HD-DVDs when the object lens 122 is focused on a recording surface of the HD-DVD. In this case, when FIGS. 4 and 5 are compared with each other, the intensity fe3 of the S-curve, output from the PD 104 for CDs when the HD-DVD is seated, is less than the intensity fe1 of the S-curve, output from the PD 104 for CDs when the CD is seated. Therefore, the type of seated optical disk is discriminated on the basis of a ratio or difference between the intensities fe3 and fe1 and a ratio or difference between the intensity fe3 of the S-curve, output from the PD 104 for CDs, and the intensity fe4 of a S-curve, output from the PD 106 for HD-DVDs.

However, it is preferable to additionally use the timing of S-curves together with the above-described difference or ratio between the intensities of the S-curves at the time of discriminating the type of optical disk, thus collectively discriminating the type of seated optical disk. Further, in the embodiment, a case where the type of optical disk is discriminated using the detection results of the PD 104 for CDs and the PD 106 for HD-DVDs is described as an example. However, the discrimination can also be carried out using detection results of the PD 104 for CDs and the PD 105 for DVDs. Moreover, the discrimination of the type of optical disk can also be carried out using detection results of the PD 105 for DVDs and the PD 106 for HD-DVDs. In addition, the discrimination can also be carried out using detection results of all of the PD 104 for CDs, the PD 105 for DVDs, and the PD 106 for HD-DVDs. In brief, the present invention can be applied to a case where the type of optical disk is discriminated using detection results of at least two of plural installed PDs.

Further, in this embodiment, a method of discriminating CD and HD-DVD is described, but the types of recordable optical disks, such as CD-R (recordable), CD-RW (rewritable), DVD−R, DVD−RW, DVD-RAM (Random Access Memory), DVD+R and DVD+RW, can be discriminated by obtaining each difference or ratio between outputs of corresponding PDs in the same manner as the embodiment.

As described above, the embodiment collectively discriminates the type of seated optical disk using detection results of at least two of plural PDs which are installed for different plural wavelengths and/or track pitches, thus discriminating the types of various kinds of optical disks seated on an information recording and reproducing system with high precision. In the embodiments of the present invention, LDs are independently provided for three systems, such as CDs, DVDs and HD-DVDs, but the same effect as those of the embodiments can be obtained even though LDs for CDs and DVDs are combined into one and so LDs are provided for two systems.

As described above, the present invention provides an apparatus and method for discriminating optical disks, which can discriminate the type of optical disk on the basis of more information than is included in light which can be reflected from the optical disk using detection results of the first and second detecting elements having different characteristics, thus discriminating various kinds of optical disks seated on an information recording and reproducing system with high precision.

Further, the present invention is advantageous in that it uses signal levels of S-curves generated by feedback light received by PDs for different wavelengths and/or track pitches at the time of discriminating the type of seated optical disk, so the type of optical disk is collectively discriminated using the signal levels together with the timing of generation of the S-curves used in the prior art, thus providing an information recording and reproducing system improved in precision and reliability of discrimination.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of discriminating types of plural discs with different track pitches and/or different reflection factors and/or different cover layer thicknesses, the disks being seated on an information recording and reproducing system that records and reproduces information using different wavelengths, comprising the steps of:
a) irradiating laser light with a specific wavelength onto an optical disk;
b) detecting light, which can be obtained by irradiating the laser light onto the optical disk, using a first detecting element suitable for light with the specific wavelength and/or for specific track pitch;
c) detecting light, which can be obtained by irradiating the laser light onto the optical disk, using a second detecting element suitable for light with another wavelength and/or for another-track pitch; and
d) discriminating a type of optical disk on the basis of detection results obtained at the steps b) and c).

2. A method of discriminating types of disks seated on an information recording and reproducing system using a S-curve indicated by a focus error signal generated during movement of an object lens by a lens drive system, comprising the steps of:
storing and maintaining a signal level of a S-curve generated by feedback light which is emitted from a light source installed for a first optical disk and received by a light receiving element installed for a second optical disk; and
utilizing the signal level for discrimination of the types of disks.

3. An apparatus for discriminating types of disks seated on an information recording and reproducing system that records and reproduces information using different plural wavelengths, comprising:
at least two detecting elements having different detection sensitivities and/or different track pitches; and
a discriminating unit for discriminating the types of optical disks on the basis of detection results which can be obtained by detecting light received from each of the optical disks through the detecting elements.

4. An apparatus for discriminating types of disks seated on an information recording and reproducing system using a S-curve indicated by a focus error signal generated during movement of an object lens by a lens drive system, comprising:
optical disk discriminating means for storing and maintaining a signal level of a S-curve generated by feedback light which is emitted from a light source installed for a first optical disk and received by a light receiving element installed for a second optical disk, and utilizing the signal level for discrimination of the types of disks.

5. The optical disk discriminating apparatus according to claim 4, wherein the optical disk discriminating means comprises a comparing circuit for discriminating a type of seated optical disk by comparing a voltage level indicated by the S-curve of the focus error signal with a voltage level generated by the feedback light, and/or comparing the voltage level generated by the feedback light with a reference value obtained when a suitable optical disk is seated.
